(19) United States
(12) Patent Application Publication
(10) Pub. No.: US 2005/0195070 A1
(43) Pub. Date: Sep. 8, 2005

(54) Safety flashers & lights

(76) Inventor: Arthur L. Tellez, Queen Creek, AZ (US)

Correspondence Address: Arthur Tellez, 17811 E. Starflower Dr., Queen Creek, AZ, 85242, US

(21) Appl. No.: 10/945,508

(22) Filed: Feb. 18, 2005

Related U.S. Application Data
(60) Provisional application No. 60/516,640, filed on Nov. 3, 2003.

(51) Int. Cl. G08B 21/00

(52) U.S. Cl. 340/431; 340/471

(57) ABSTRACT

Thus apparatus is used to control flashing lights on a disabled refrigerated trailer. The apparatus is using the battery from the trailer to control the lights & flashers on the trailer. By removing the plug on the trailer and plugging in the safety box thereby causing lights and flashers to warn oncoming traffic of a disabled vehicle: thus allowing the driver to then put out his flares and triangles. At the time of connection the refrigerated trailer should be running Also saving the batteries on the truck so they are not run down so that a mechanic can restart the vehicle. If truck has to be separated from the trailer the lights and flashers will remain working. The unit is also portable for mechanic's on service calls.

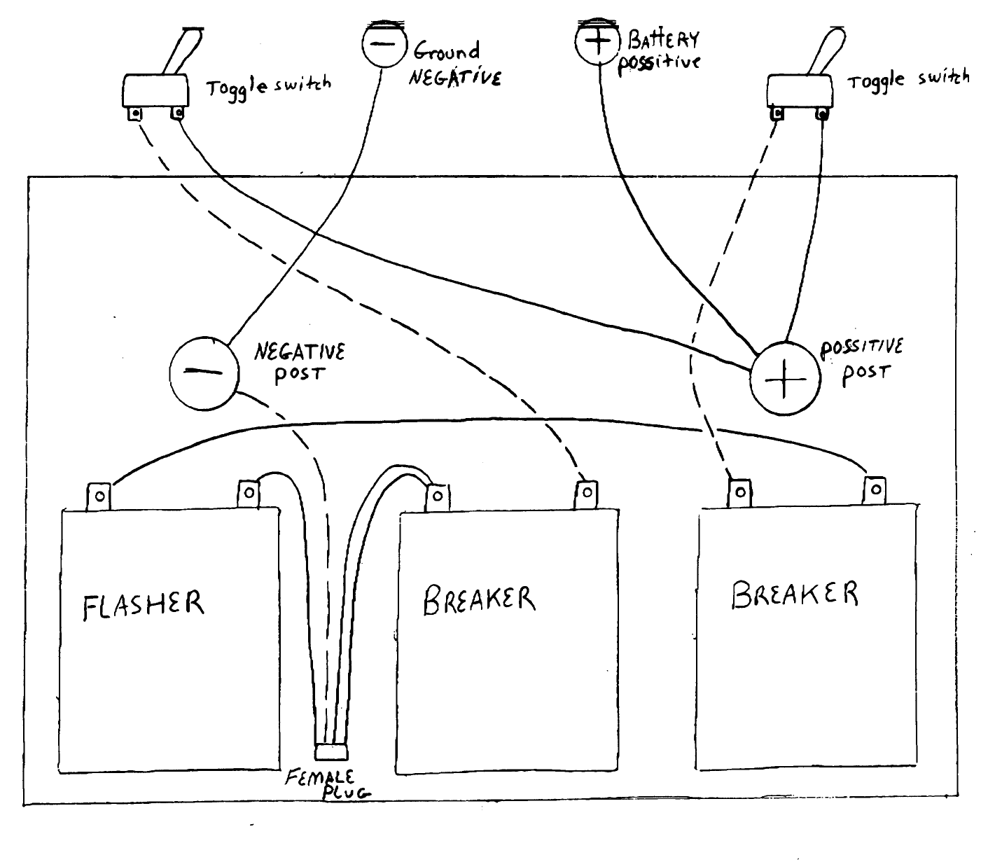

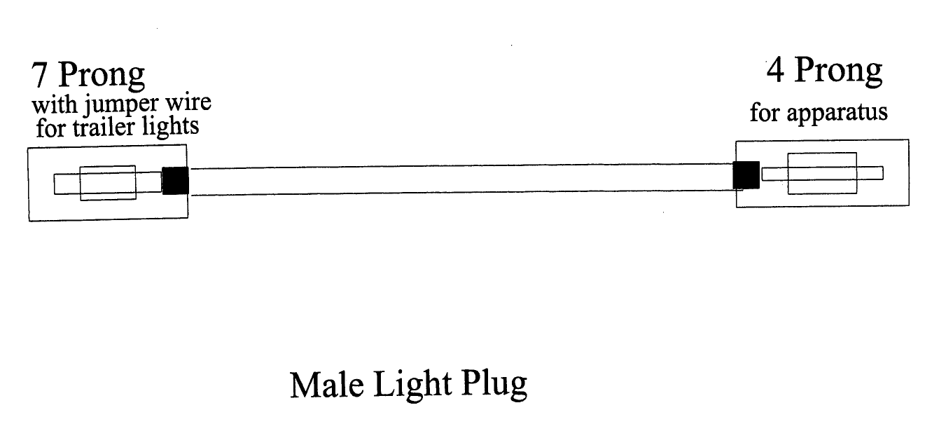

This is an apparatus used to control the lights and 4 way flashers on a disabled refrigerated trailer by using the battery from the unit. This will save the batteries from the truck.

By removing the plug on the trailer and connecting the safety box This causes the lights and 4 way flashers to warn oncoming traffic if this disabled vehicle.

This will allow the driver to put out triangles to prevent an accident.

At the time of connection the unit should be started and running.

The item Safety Flashers and Lights

1. I claim 1 have invented the above item without copying any other item. This is my idea solely.
I invented this to be used in my course of business. I saw the need and put the idea to use.
